(19) United States
(12) Patent Application Publication
(10) Pub. No.: US 2017/0078553 A1
(43) Pub. Date: Mar. 16, 2017

(54) METHOD OF DETERMINING A DURATION OF EXPOSURE OF A CAMERA ON BOARD A DRONE, AND ASSOCIATED DRONE

(71) Applicant: PARROT DRONES, Paris (FR)

(72) Inventors: Eng Hong Sron, Paris (FR); Benoit Pochon, Vincennes (FR)

(21) Appl. No.: 15/258,936

(22) Filed: Sep. 7, 2016

(30) Foreign Application Priority Data
Sep. 14, 2015 (FR) 1558567

(51) Int. Cl. H04N 5/235; G06T 7/00

(52) U.S. Cl. CPC H04N 5/2353; H04N 5/2351; G06T 7/0018; G06T 2207/10016; G06T 2207/10032; G06T 2207/30241

(57) ABSTRACT

The invention relates to a method of dynamically determining the duration of exposure for the capture of an image implemented in a drone comprising a substantially vertical-view camera. The method comprises a step (21) of measuring of the horizontal speed of displacement of the drone, a step (22) of measuring the distance between said drone and the ground, and a step (23) of determining the duration of exposure based on the measured speed of displacement of the drone, the distance measured between said drone and the ground, a predetermined quantity of blurring and the focal length of said camera.

The invention relates to a method of dynamically determining the duration of exposure of a scene for the capture of an image by a camera placed on board a drone, and a drone having a camera on board and comprising such a method.

The AR.Drone 2.0, the Bebop Drone of Parrot SA, Paris, France, or the eBee of SenseFly SA, Swiss, are typical examples of drones. They are equipped with a series of sensors (accelerometers, 3-axis gyrometers, altimeters) and at least one camera. This camera is for example a vertical-view camera capturing an image of the overflown ground or a front-view camera capturing an image of the scene in front of the drone. These drones are provided with one motor or several rotors driven by respective motors, able to be controlled in a differentiated manner so as to pilot the drone in attitude and speed.

It is known in particular from the document US2013/325217 a drone comprising a vertical-view camera pointing downward to evaluate the speed of the drone with respect to the ground and an ultrasound telemeter and an on-board barometric sensor that provide measurements to estimate the altitude of the drone with respect to the ground.

The invention more particularly relates to a method of dynamically determining the duration of exposure to be applied for the capture of an image by the camera on board a drone to capture an image of the overflown ground or of the scene viewed by the front camera.

The word “exposure” means the total quantity of light received by the sensitive surface, in particular the digital sensor of the digital camera during the image taking.

And the duration of exposure is the time interval for which the camera shutter lets the light pass through during an image taking, and hence the duration, in the case of a digital camera, for which the sensor receives the light.

The exposure is also dependant on the sensitivity parameter. The sensitivity, expressed in ISO, is the measurement of the sensitivity to light of the digital sensors. This is a data element that is essential to the determination of a correct exposure.

A captured image is correctly exposed when the sensitive surface receives the good quantity of light: that which allows obtaining an image that is neither too clear nor too dark.

To obtain this correct exposure, the cameras are equipped with an auto-exposure (AE) algorithm, which has for function to choose a couple consisted of the duration of exposure and the sensor sensitivity, in order to sense any scene with a target brightness.

These drones equipped with such a camera are controlled during the flying over of the land to be mapped via a control device or through the loading of a trajectory that the drone follows autonomously.

The capture of images is performed either by the successive triggering of the camera equipping the drone, or by the reception of a camera-triggering command, for example, from the user of the drone.

It is known that exposure determination methods are based on an interval of validity for the time of exposure and the sensor sensitivity.

Moreover, exposure determination methods are known, which set up a table of correspondence between the sensor sensitivity and the duration of exposure as a function of the brightness of the scene. These methods hence allow having steps and adapting at best the couple, sensor sensitivity/duration of exposure, relative to the brightness of the scene to be captured.

These solutions have for drawback to be based on parameters fixed in advance, in particular based on a narrow set of couples, sensitivity/duration of exposure. The brightness of the scene, which is estimated at the time of the capture, allows determining the better couple, sensor sensitivity/duration of exposure, among all the parameterized couples.

In the case of use of these known methods, during their implementation in a camera on board a drone, it has been observed that a too long time of exposure causes a blurred image, in particular due to the movement of the camera, both in rotation and in translation.

Likewise, it has been observed that, when the sensor sensitivity is high, the noise of the scene is increased. The noise is the presence of spurious information that is randomly added to the details of the digitally captured scene. It is more particularly visible in areas that are not very lighted up, in which the signal/noise ratio is low, but also in the uniform parts such as a blue sky. It has hence for consequence the loss of clearness in the details.

An exposure is correct when the captured image comprises a minimum of noise and an acceptable blurring.

Within the framework of a camera on board a drone, the camera undergoes the movements in rotation and the movements in translation of the drone.

The known methods of auto-exposure do not allow an adaptation of the duration of exposure to the movement constraints of the drone.

The object of the present invention is to remedy these drawbacks, by proposing a solution allowing dynamically determining the duration of exposure for the capture of an image implemented in a drone so as to capture an image having a minimum of noise and an acceptable blurring.

For that purpose, the invention proposes a method of dynamically determining the duration of exposure for the capture of an image implemented in a drone comprising a substantially vertical-view camera. The method is characterized in that it comprises:
a step of measuring the horizontal speed of displacement of the drone,
a step of measuring the distance between said drone and the ground (Z), and
a step of determining the duration of exposure based on the measured speed of displacement of the drone, the distance measured between said drone and the ground (Z), a predetermined quantity of blurring (du) and the focal length (f) of said camera.

According to an embodiment, the duration of exposure (Tₑₓₚ) is defined by:

Tₑₓₚ=du*Z/f*∥\vec{v}∥

with Z the distance measured between said drone and the ground,
du the quantity of blurring,
f the focal length, and
∥v∥ the horizontal speed of displacement of said drone.

In a particular embodiment, the method further comprises a step of determining a second duration of exposure based on the focal length (f) of said camera, a predetermined quantity of blurring (du) and the speed of rotation (ω) of said drone.

According to an embodiment, the second duration of exposure (Tₑₓₚ) is defined by:

Tₑₓₚ=du*a tan(1/f)/ω

with du the quantity of blurring,
ω the speed of rotation of said drone, and
f the focal length.

According to a particular embodiment, the quantity of blurring (du) is determined by the displacement of the scene in the image plane between the instant of beginning and the instant of end of the exposure.

According to an embodiment, the focal length of said camera and the quantity of blurring are expressed in pixels.

According to a particular embodiment, the focal length expressed in pixels (fₚᵢₓₑₗ) is defined by:

fₚᵢₓₑₗ=fₘₘ/pixPitch

with fₘₘ the focal length of the camera expressed in millimetres, and
pixPitch the size of one pixel in the image plane in millimetres on the scene.

The invention also proposes a method of dynamically determining the effective duration of exposure for the capture of an image implemented in a drone comprising a substantially vertical camera, characterized in that the method comprises a step of determining the effective duration of exposure, said effective duration of exposure being the minimum duration between the duration of exposure determined in accordance with the above-described invention and the second duration of exposure determined in accordance with the above-described invention.

The invention also proposes a drone comprising a substantially vertical camera adapted to implement the method of dynamically determining the duration of exposure for the capture of an image by said camera in accordance with the described invention.

An example of implementation of the present invention will now be described, with reference to the appended drawings.

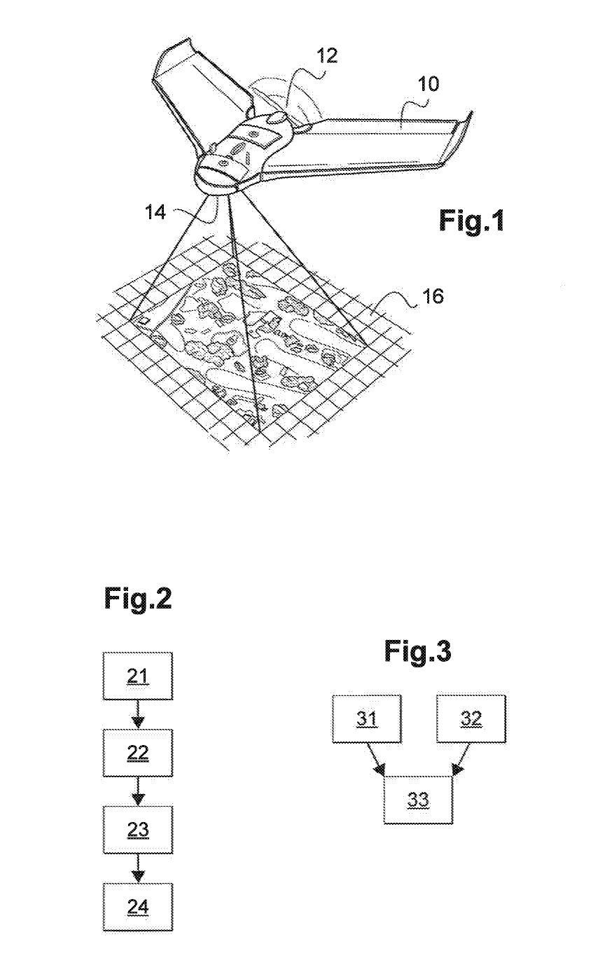

FIG. 1 illustrates a drone and a land to be mapped.

FIG. 2 illustrates a method of determining a duration of exposure according to the invention.

FIG. 3 illustrates a method of determining an effective duration of exposure according to the invention.

We will now describe an exemplary embodiment of the invention.

In FIG. 1, the reference 10 generally denotes a drone. According to the example illustrated in FIG. 1, it is a flying wing such as the eBee model of SenseFly SA, Swiss. This drone includes a motor 12.

According to another exemplary embodiment, the drone is a quadricopter such as the Bebop drone model of Parrot SA, Paris, France. This drone includes four coplanar rotors whose motors are piloted independently from each other by an integrated navigation and attitude control system.

In the exemplary embodiment of a quadricopter, the drone is provided with inertial sensors (accelerometers and gyrometers) making it possible to measure with a certain accuracy the angular speeds and the attitude angles of the drone, i.e. the Euler angles (pitch φ, roll θ and yaw ψ) describing the inclination of the drone with respect to a horizontal plane of a fixed terrestrial reference system UVW, it being understood that the two longitudinal and transverse components of the horizontal speed are intimately linked to the inclination about to the two respective pitch and roll axis. According to this embodiment, the drone 10 is piloted by a remote-control device, such as a touch-screen multimedia telephone or tablet having integrated accelerometers, for example a cellular phone of the iPhone type (registered trademark) or else, or a tablet of the iPad type (registered trademark) or else. It is a standard device, not modified except the loading of a specific applicative software to control the piloting of the drone 10.

The exemplary embodiment illustrated in FIG. 1, the drone is piloted by a particular remote-control device allowing in particular a control of the drone from a very long distance.

The user may control in real time the displacement of the drone 10 via the remote-control device or program a determined route that will be loaded in the drone before the take-off.

The remote-control device communicates with the drone 10 via a bidirectional exchange of data by a wireless link of the Wi-Fi (IEEE 802.11) or Bluetooth (registered trademarks) local network type.

The drone 10 is provided with an on-board, vertical-view camera 14 making it possible to obtain a set of images, for example images of the land to be mapped 16, a land that is overflown by the drone.

The drone 10 may also be provided with an on-board front camera allowing the capture of the scene in front of the drone.

According to the invention, the drone comprises a method of dynamically determining the duration of exposure for the capture of an image implemented in a drone comprising a camera, in particular a substantially vertical-view camera.

This method of dynamically determining the duration of exposure for the capture of an image, according to a particular embodiment, is implemented in the camera 14 placed on board a drone.

According to the invention, the method of dynamically determining the duration of exposure allows determining the duration of exposure in continuous as a function of the flight parameters of the drone and of the characteristics of the camera 14.

Indeed, it has been observed that the movement of translation of the drone creates a blurring by motion having an amplitude that depends on the distance of the scene to be captured, the focal length of the lens, the duration of exposure and the speed of displacement (horizontal and vertical) of the drone.

Moreover, it has been observed that the movement of rotation of the drone creates a blurring by motion having an amplitude that depends on the focal length of the lens, the duration of exposure and the angular speed of the drone.

Hence, it is necessary to take into account the flight parameters of the drone and the characteristics of the camera 14 in order to dynamically determine the duration of exposure of the sensor of the camera 14 in order to make a capture of image of good quality.

That way, the duration of exposure is not defined in advance but is determined dynamically during the capture of the image, and determined as a function of the dynamic characteristics of the drone and of the scene to be captured.

In particular, the duration of exposure will be determined based on the speed of displacement of the drone 10, the distance between the drone and the ground Z, a predetermined quantity of blurring du and the focal length f of the camera 14.

For determining the duration of exposure, in particular in order to take into account the movement in translation of the drone, the distance Z between the drone and the ground is determined.

The distance Z between the drone and the ground is also extended by the distance between the camera on board the drone and the ground.

According to a first embodiment, the distance Z between the drone and the ground may be determined by a measurement of altitude given for example by a GPS module equipping the drone, at the time of take-off and then at regular intervals during the flight. That way, the distance Z between the drone et the ground is approximately determined. This embodiment is particularly pertinent when the drone flies over a planar ground.

According to another embodiment, the distance Z between the drone and the ground is determined by a drone altitude estimation device. This device comprises for example an altitude estimator system based on the measurements of a barometric sensor and an ultrasound sensor as described in particular in the document EP 2 644 240 in the name of Parrot SA.

The distance Z between the drone and the ground is expressed in metres.

As seen hereinabove, the duration of exposure will be determined in particular as a function of an acceptable quantity of blurring.

The quantity of blurring du is function of the focal length f of the lens of the camera 14, the distance between the drone and the ground and the scene displacement dX, in particular in the image plane, between the instant of beginning and the instant of end of the exposure.

Hence, the quantity of blurring is defined in accordance with the formula:

duₚₓ=fₚᵢₓₑₗ*dX/Z

with f the focal length of the camera,
dX the distance of displacement of a scene between the instant of beginning and the instant of end of the exposure, and
Z the altitude of said drone.

The quantity of blurring du and the focal length f may be expressed in millimetres. According to an alternative embodiment, the quantity of blurring du and the focal length f are expressed in pixels.

The focal length expressed in pixels (fₚᵢₓₑₗ) is defined by:

fₚᵢₓₑₗ=fₘₘ/pixPitch

with fₘₘ the focal length of the camera expressed in millimetres, and
pixPitch the size of one pixel in the image plane in millimetres on the scene.

The scene displacement dX, in particular in the image plane, between the instant of beginning and the instant of end of the exposure corresponds in particular to the horizontal displacement of the scene, in particular in the case of the flying wing illustrated in FIG. 1.

The scene displacement dX is in particular dependent on the horizontal speed of displacement of the drone 10. According to an embodiment, the speed is measured by an inertial unit placed on board the drone 10. According to another embodiment, the speed is measured by analysing the displacement of the overflown portion of land.

Hence, the distance of displacement of a scene dX between the instant of beginning and the instant of end of the exposure is determined by the formula:

dX=∥\vec{v}∥*Tₑₓₚ

with ∥v∥ the horizontal speed of displacement of said drone, and
Tₑₓₚ the duration of exposure.

The horizontal speed is expressed in metres per second and the duration of exposure in seconds.

Hence, the method of dynamically determining the duration of exposure for the capture of an image implemented on the drone 10, in particular in the camera 14, in accordance with the invention, as illustrated in FIG. 2, comprises a step 21 of measuring the horizontal speed of displacement of the drone, a step 22 of measuring the distance between said drone and the ground Z, and a step 23 of determining the duration of exposure based on the measured speed of displacement of the drone, the distance measured between said drone and the ground Z, a predetermined quantity of blurring du and the focal length f of said camera.

The steps 21 of measuring the horizontal speed of displacement of the drone, and 22 of measuring the distance between said drone and the ground Z may be executed in the opposite direction or in parallel.

The duration of exposure Tₑₓₚ defined during the step 23 is determined according to a particular embodiment in accordance with the equation:

$${T}_{exp} = \frac{du * Z}{f * ‖ {v}^{->} ‖}$$

with Z the distance measured between said drone and the ground,
du the quantity of blurring,
f the focal length, and
∥v∥ the horizontal speed of displacement of the drone.

Hence, the duration of exposure dynamically determined is function of the flight parameters of the drone 10 at the instant of capture of the image, the parameters of the camera 14 and the acceptable quantity of blurring. The quantity of blurring is determined as a function of the final application of the image and may hence take different values, for example 1 pixel or 4 pixels.

According to a particular embodiment, the method of determining, according to the invention, is adapted to determine a second duration of exposure in particular in order to take into account the movement of rotation of the drone 10.

Hence, the second duration of exposure is determined based on the focal length f of said camera 14, a predetermined quantity of blurring du and the speed of rotation ω of said drone 10.

In order to determine the observed angle in pixels, the variable dResAng is defined in accordance with the following formula:

$$dResAng = atan ( \frac{1}{{f}_{px}} )$$

with fₚₓ the focal length of the camera expressed in pixels.

Then, the angle dθ covered for the duration of exposure is determined in accordance with the formula:

dθ=ω*Tₑₓₚ

with ω the speed of rotation of said drone, and
Tₑₓₚ the duration of exposure.

Hence, the distance covered for the duration of exposure du, expressed for example in pixels, is determined in accordance with the following formula:

$${du}_{px} = d θ / dResAng = \frac{ω * {T}_{exp}}{atan ( \frac{1}{{f}_{px}} )}$$

with dθ the angle covered for the duration of exposure,
Tₑₓₚ the duration of exposure,
fₚₓ the focal length expressed in pixels,
ω the speed of rotation of said drone, and
dResAng the observed angle in pixels.

The speed of rotation ω of said drone 10 may be determined for example, before the triggering of the image capture or may be averaged over a determined duration. This speed is expressed in degrees per second.

It is hence deduced that the second duration of exposure Tₑₓₚ, in order to take into account the movement of rotation of the drone 10, is defined by:

$${T}_{exp} = \frac{du * atan ( \frac{1}{f} )}{ω}$$

with du the quantity of blurring,
ω the speed of rotation of said drone, and
f the focal length of the camera.

It is to be noted that this method of determining adapted to determine a duration of exposure in order to take into account the movement of rotation of the drone is applicable to a substantially vertical-view camera and to a substantially horizontal-view camera.

According to a particular embodiment, the method of dynamically determining the duration of exposure for the capture of an image implemented in a drone 10, in particular in the camera 14, further comprises, as illustrated in FIG. 2, a step 24 of determining a second duration of exposure based on the focal length f of said camera, a predetermined quantity of blurring du and the speed of rotation ω of said drone 10.

The step 24 may be executed sequentially before or after the steps 21 to 23 or be executed in parallel with the steps 21 to 23.

According to a particular embodiment, the invention further comprises a method of dynamically determining the effective duration of exposure for the capture of an image implemented in a drone 10 comprising a substantially vertical-view camera 14.

This method, illustrated in FIG. 3, comprises a step 31 of determining a first duration of exposure for the capture of an image in order to take into account the movement in translation of the drone 10. This step 31 is implemented according to steps 21 to 23 of FIG. 2 and described hereinabove.

The method of dynamically determining the effective duration of exposure comprises a step 32 of determining a second duration of exposure for the capture of an image in order to take into account the movement in rotation of the drone 10. This step 32 is implemented according to step 24 of FIG. 2 and described hereinabove.

Steps 31 and 32 may be executed sequentially or in parallel.

Steps 31 and 32 are followed with a step 33 of determining the effective duration of exposure, said effective duration of exposure being the minimum duration between the first duration of exposure determined at step 31 and the second duration of exposure determined at step 32.

The invention also relates to a drone 10 comprising a camera 14, for example a substantially vertical camera, adapted to implement the above-described method(s) of dynamic determining the duration of exposure for the capture of an image by said camera.

By way of non-limitative example, it is considered, at the instant t, that the drone 10 having a camera 14 on board and equipped with said method of dynamically determining a duration of exposure in accordance with the invention, as described hereinabove, flies at a speed of 36 km/h, that the acceptable blurring is of 2 pixels, that the distance between the drone and the ground is of 50 metres and that the speed of rotation is of 100°/sec.

According to this example and in the case of a camera having a focal length of 3.98 mm and a size of one pixel in the image plane in millimetres on the scene of 3.75 μmetres then the duration of exposure of the sensor according to the invention is of 9.42 milliseconds in order to take into account the movement in translation of the drone and of 1.08 milliseconds in order to take into account the movement in rotation of the drone.

According to the considered example of the drone and in the case of a camera having a focal length of 4.88 mm and a size of one pixel in the image plane in millimetres on the scene of 1.34 μmetres then the duration of exposure of the sensor according to the invention is of 2.75 milliseconds in order to take into account the movement in translation of the drone and of 0.31 milliseconds in order to take into account the movement in rotation of the drone.

1. A method of dynamically determining the duration of exposure for the capture of an image implemented in a drone, comprising a substantially vertical-view camera, characterized in that it comprises:
a step (21) of measuring the horizontal speed of displacement of the drone,
a step (22) of measuring the distance between said drone and the ground (Z), and
a step (23) of determining the duration of exposure based on the measured speed of displacement of the drone, the distance measured between said drone and the ground (Z), a predetermined quantity of blurring (du) and the focal length (f) of said camera.

2. The method of determining according to claim 1, characterized in that the duration of exposure (Tₑₓₚ) is defined by:
$${T}_{exp} = \frac{du * Z}{f * ‖ {v}^{->} ‖}$$
with Z the distance measured between said drone and the ground,
du the quantity of blurring,
f the focal length, and
∥v∥ the horizontal speed of displacement of said drone.

3. The method of determining according to claim 1, characterized in that the method further comprises a step of determining a second duration of exposure (24) based on the focal length (f) of said camera, a predetermined quantity of blurring (du) and the speed of rotation (ω) of said drone.

4. The method of determining according to claim 3, characterized in that the second duration of exposure (Tₑₓₚ) is defined by:
$${T}_{exp} = \frac{du * atan ( \frac{1}{f} )}{ω}$$
with du the quantity of blurring,
ω the speed of rotation of said drone, and
f the focal length.

5. The method of determining according to claim 4, characterized in that the quantity of blurring (du) is determined by the displacement of the scene in the image plane between the instant of beginning and the instant of end of the exposure.

6. The method of determining according to claim 5, characterized in that the focal length of said camera and the quantity of blurring are expressed in pixels.

7. The method of determining according to claim 6, characterized in that the focal length expressed in pixels (fₚᵢₓₑₗ) is defined by:
$${f}_{pixel} = \frac{{f}_{mm}}{pixPitch}$$
with fₘₘ the focal length of the camera expressed in millimetres, and
pixPitch the size of one pixel in the image plane in millimetres on the scene.

8. A method of dynamically determining the duration of exposure for the capture of an image implemented in a drone, comprising a substantially vertical-view camera, characterized in that the method comprises a step of determining the effective duration of exposure, said effective duration of exposure being the minimum duration between
a first duration of exposure determined by
a step (21) of measuring the horizontal speed of displacement of the drone,
a step (22) of measuring the distance between said drone and the ground (Z), and
a step (23) of determining the duration of exposure based on the measured speed of displacement of the drone, the distance measured between said drone and the ground (Z), a predetermined quantity of blurring (du) and the focal length (f) of said camera;
and
a second duration of exposure determined based on the focal length (f) of said camera, a predetermined quantity of blurring (du) and the speed of rotation (ω) of said drone.

9. A drone comprising a substantially vertical-view camera adapted to implement a method of dynamically determining a duration of exposure for capture of an image by said camera by:
measuring horizontal speed of displacement of the drone,
measuring distance between said drone and the ground (Z), and
determining duration of exposure based on the measured speed of displacement of the drone, the distance measured between said drone and the ground (Z), a predetermined quantity of blurring (du) and the focal length (f) of said camera.

10. The method of determining according to claim 2, characterized in that the method further comprises a step of determining a second duration of exposure (24) based on the focal length (f) of said camera, a predetermined quantity of blurring (du) and the speed of rotation (ω) of said drone.

11. The method of determining according to claim 4, characterized in that the focal length of said camera and the quantity of blurring are expressed in pixels.

12. The method of determining according to claim 8, characterized in that the first duration of exposure (Tₑₓₚ) is defined by:
$${T}_{exp} = \frac{du * Z}{f * ‖ {v}^{->} ‖}$$
with Z the distance measured between said drone and the ground,
du the quantity of blurring,
f the focal length, and
∥v∥ the horizontal speed of displacement of said drone.

13. The method of determining according to claim 8, characterized in that the second duration of exposure (Tₑₓₚ) is defined by:
$${T}_{exp} = \frac{du * atan ( \frac{1}{f} )}{ω}$$
with du the quantity of blurring,
ω the speed of rotation of said drone, and
f the focal length.

14. The method of determining according to claim 13, characterized in that the quantity of blurring (du) is determined by the displacement of the scene in the image plane between the instant of beginning and the instant of end of the exposure.

15. The method of determining according to claim 14, characterized in that the focal length of said camera and the quantity of blurring are expressed in pixels.

16. The method of determining according to claim 15, characterized in that the focal length expressed in pixels (fₚᵢₓₑₗ) is defined by:
$${f}_{pixel} = \frac{{f}_{mm}}{pixPitch}$$
with fₘₘ the focal length of the camera expressed in millimetres, and
pixPitch the size of one pixel in the image plane in millimetres on the scene.

17. The drone according to claim 9, characterized in that the duration of exposure (Tₑₓₚ) is defined by:
$${T}_{exp} = \frac{du * Z}{f * ‖ {v}^{->} ‖}$$
with Z the distance measured between said drone and the ground,
du the quantity of blurring,
f the focal length, and
∥v∥ the horizontal speed of displacement of said drone.

18. The drone according to claim 9, characterized in that the method further comprises determining a second duration of exposure (24) based on the focal length (f) of said camera, a predetermined quantity of blurring (du) and the speed of rotation (ω) of said drone.

19. The drone according to claim 18, characterized in that the second duration of exposure (Tₑₓₚ) is defined by:
$${T}_{exp} = \frac{du * atan ( \frac{1}{f} )}{ω}$$
with du the quantity of blurring,
ω the speed of rotation of said drone, and
f the focal length.

20. The drone according to claim 19, characterized in that the quantity of blurring (du) is determined by the displacement of the scene in the image plane between the instant of beginning and the instant of end of the exposure.

21. The drone according to claim 20, characterized in that the focal length of said camera and the quantity of blurring are expressed in pixels.

22. The drone according to claim 21, characterized in that the focal length expressed in pixels (fₚᵢₓₑₗ) is defined by:
$${f}_{pixel} = \frac{{f}_{mm}}{pixPitch}$$
with fₘₘ the focal length of the camera expressed in millimetres, and
pixPitch the size of one pixel in the image plane in millimetres on the scene.
